(19) United States
(12) Patent Application Publication
(10) Pub. No.: US 2018/0037274 A1
(43) Pub. Date: Feb. 8, 2018

(54) Cargo Slide for a Pickup Truck

(71) Applicant: Edward Mathis, Fort Myers, FL (US)

(72) Inventor: Edward Mathis, Fort Myers, FL (US)

(21) Appl. No.: 15/231,465

(22) Filed: Aug. 8, 2016

(51) Int. Cl. B62D 33/02; B60P 1/00

(52) U.S. Cl. CPC B62D 33/0207; B60P 1/00

(57) ABSTRACT

The invention is directed to a cargo moving apparatus for moving cargo within a bed of a pickup truck. The cargo moving apparatus includes a male and female guide rails and a bed slide. The female guide rails can be attachable to the pickup truck and extend a length of the truck. The male guide rails can be attached to the bed slide. The female guide rails and male guide rails include a track formed along the rails top and bottom surface, respectively. For example, the tracked formed may be of a tubular shape wherein the female track is an outer tube that almost encompasses the inner tube of the male track. The female and male tracks of the female and male guide rails can mate or interface and when the bed slide is moved from forward to rearward position the interface of the male and female tracks allow the slide to be easily moved.

### TECHNICAL FIELD

The present invention relates to the field of labor saving pickup truck accessories. More specifically, the invention comprises a cargo slide for sliding cargo items from the front of a bed of an pickup truck toward the rear of the bed where they can be easily reached by the user.

### BACKGROUND

A pickup truck, for example, is often used to transport cargo. As most will understand, the cargo typically ends up at the front wall of the pickup, near the cab. Even if the cargo is placed near the tailgate, the cargo typically ends up in this position under normal driving conditions. As such, it is not uncommon for a user to have a situation where the cargo lies near the front wall, well out of reach. The user is then faced with climbing into the bed of the pickup truck in order to retrieve the cargo or otherwise reach into the bed and move the cargo to a desired position for unloading. In either case, this may be undesirable and, in some circumstances, perhaps not possible. For older or physically challenged users, it simply may not be possible. Thus, it would be useful to have some means to bring the cargo from the position back toward the tail gate.

In addition, bed covers are another increasingly popular accessory. These cover the open top of the pickup truck bed and shelter the bed from the weather. The user can still store cargo in the bed by opening the tailgate and accessing the bed from the rear. When cargo winds up in the forward portion of the bed, however, the presence of a bed cover presents a substantial impediment to unloading that cargo. Although most covers can be opened in some fashion. The step is often time-consuming and laborious.

Furthermore, bed slides are not a new commercial enterprise. Bed slides have been around for sometime but have only recently begun to establish a substantial market. A quick Internet search will reveal many manufactures and many different bed slide products. However, these products are typically designed using industrial strength metals and roller bearing systems. In effect, these systems can be overly complex, expensive to manufacture, and difficult to install. With respect to installation, it is not uncommon that when these types of systems are installed, the installation is permanent or otherwise very difficult to remove. In other words, in most cases a user would need a professional to install the slide and remove the slide when it is no longer needed. This approach is not practical for those that only wish to use a bed slide for short period of time or may want to frequently switch the bed slide for use between different vehicles. In other words, there are market segments where these types of overly-engineered, expensive, heavy, and difficult to install slides may not be practical or needed.

As such, there is a need for a bed slide that is simple to manufacture, cost effective, and easy to assembly and install. The present invention satisfies these needs and provides a user with a commercially practical bed slide that facilitates the loading and unloading of cargo with a bed cover in place as well.

### SUMMARY

The example embodiments presented herein meet the above-identified needs by providing an improved cargo slide for moving cargo within a bed of a pickup truck bounded by a front wall and a tail gate.

In one embodiment, the cargo slide includes a first and second female guide rails, first and second male guide rails, and a platform. The first and second female guide rails are attachable to the bed of the pickup truck. The first and second male guide rails are attachable to the platform and slideable mateable with the first and second female guide rails. The first and second female guide rails have a female track formed therein, wherein the female track is tubular and extends a length of the female guide rail. The first and second male guide rails also include a male track formed thereon; wherein the male track is tubular and extends a length of the male guide rail. The tubular male track can be inserted into the tubular female track and the female track will mostly encompass the male track. Once the platform is attached to the male guide rail, after the male and female guide rail are interfaced, the platform can easily slide in a rearward and forward position.

In another embodiment, the cargo slide includes a first and second female guide rails, first and second male guide rails, and a platform. The first and second female guide rails are attachable to the bed of the pickup truck. The first and second male guide rails are attachable to the platform and slideable mateable with the first and second female guide rails. The first and second female guide rails have a female track formed therein, wherein the female track includes a base bottom section and a sidewall section that is beveled, effectively forming a semi-v shape. The first and second male guide rails also include a male track formed thereon; wherein the female track includes a base bottom section and a sidewall section that is beveled, effectively forming a semi-v shape. The first and second female guide rails further include a support member that is formed with the guide rails and that continues the top surface of each guide rail and surrounds their respective male guide rail when the male and female guide are interfaced. After the male and female guide rail are interfaced and once the platform is attached to the male guide rail, the bed slide can easily slide in a rearward and forward position.

### BRIEF DESCRIPTION OF THE DRAWINGS

FIG. 1 is a perspective view of a cargo slide for an automobile that includes guide rails and a platform slideable along the guide rails according to an embodiment of the invention.

FIG. 2A is a front view of a male guide rail having a male guide track formed thereon and a female guide rail having a female guide track formed therein with each guide track have a tubular shape.

FIG. 2B is a front view of a male guide rail having and male guide track formed thereon and a female guide rail having a female guide track formed therein with each guide track having a v-shape.

FIG. 2C is a front view of a male guide rail having a male guide track formed thereon and a female guide rail having a female guide track formed therein with each guide track having a u-shape.

FIG. 3 is a perspective view of the guide rail system in an extended position.

### DETAILED DESCRIPTION OF THE PRESENTLY PREFERRED EMBODIMENTS

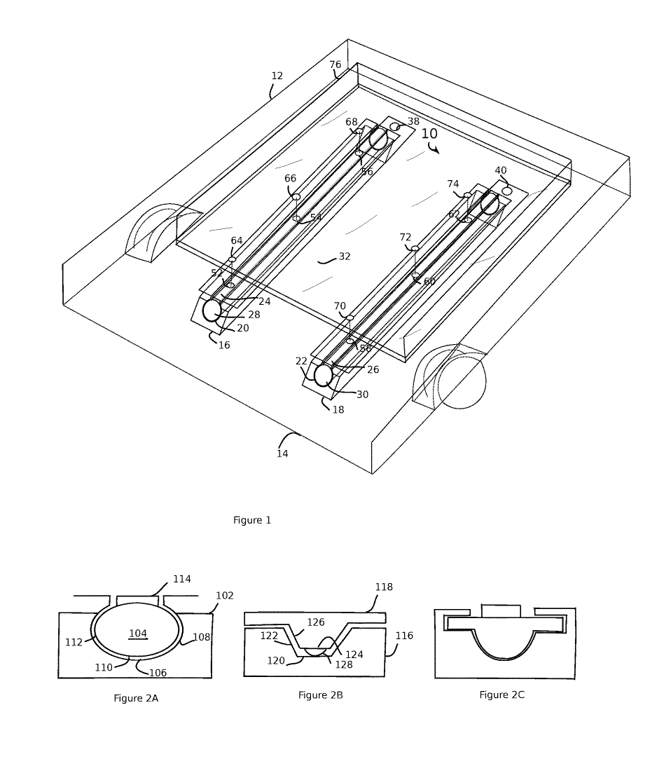

Referring to FIG. 1, a cargo slide for a pickup truck for the purpose of moving cargo in and out of the bed of the pickup truck is illustrated and denoted generally as 10. The cargo slide 10 as illustrated is positioned in the bed of a pickup truck 12 with one end facing the tailgate 14 and the other end the cab. The cargo slide 10 includes first and second female guide rails 16,18 with female tracks 20,22, formed therein and a first and second male guide rail 24,26 with male tracks 28,30, formed thereon, and a platform 32. The first and second female guide rails 16,18 can be physically attached to the bed of the truck 12, e.g. using self tapping screws, at positions 38-48. Although, it should be understood the positions for securing the male and female tracks could be placed at any locations along the female guide rail. The male guide rails 24,26 can be physically attached to the platform 32 along positions 52-62 of male guide rail 24 and 64-74 of the platform 32. It should be understood these positions represent bored out holes that allow a user to fasten the components together.

The female guide rails 16,18 when mated with the male guide rails 24,26 enable the user to easily move the platform 32 rearward toward the tailgate 14 and forward toward the cab of the pickup truck. In a preferred embodiment, the first and second female guide rails 16,18, the first and second male guide rails 24,26, and the platform 32 may be made of high density plastic, e.g. high density polyethylene. This material being suitable for manufacturing a cargo moving apparatus that is simple to manufacture, requires minimal machined parts, simple to install, cost efficient, and easy for a user to slide cargo into and out of the automobile. Although, it should be understood the guide rails may be made of wood or metal, such as aluminum. In any case, the guide rails are easy to install and easy to remove.

Additionally, cargo slide 10 may include a platform rail 76 that encompasses part of the platform 32. The platform rail 76 can be attached to or formed with the platform 32 and extends adjacent with the sides of the pickup truck and the area near the cab of the pickup truck. The platform rail 76 is useful in that it can prevents smaller items from getting trapped under the bed slide or otherwise falling off the bed slide.

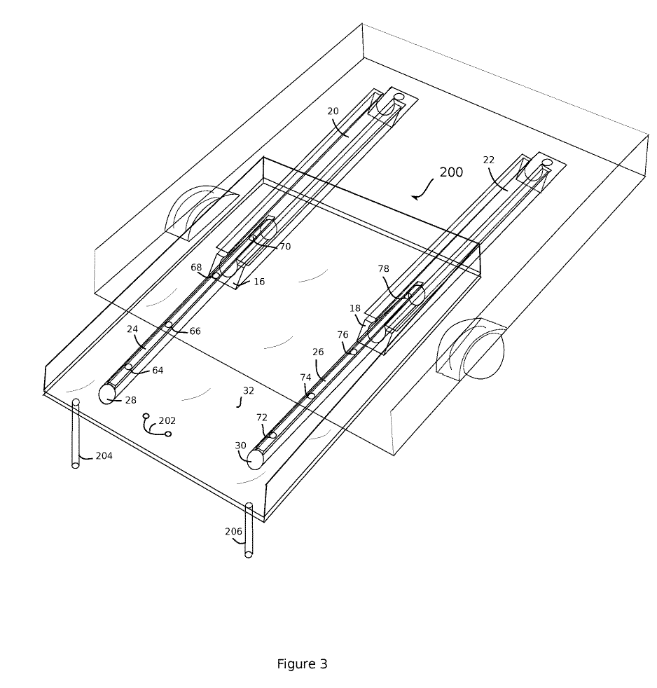

Referring now to FIGS. 2A-2C, the illustrations include a front view of the female guide rail 16,18 and male guide rails 24,26 and various embodiments in which the male and female tracks may be formed therein and thereon. Each illustration is an embodiment of the guide rails that have guide tracks that are formed to a certain shape that will facilitate the movement of cargo rearwards and forwards. The shapes formed within the guide rails are similar, which not only helps facilitate sliding by providing a stable surface but also makes manufacture of the rails easier and less expensive. As illustrated in FIGS. 2A-2C and FIG. 1, the female and male guide rails each extend horizontally with the length of the pickup truck and the female and male tracks formed therein and thereon are formed vertically with the horizontal of the respective guide rail and each track extends horizontally with the length of the pickup truck.

In FIG. 2A, illustrated is a female guide rail 102 and male guide rail 104 wherein the tracks formed therein are of a tubular shape, as illustrated in FIG. 1. The female guide rail 102 is shaped so as to form a female track that includes a base portion 106 and sidewall portion 108 that continues the base portion 106. It should be understood that the base and sidewall portion 106,108 are a continuous integrated piece. In this embodiment, the shape of the track is of a tubular shape. The male guide rail 104 is also shaped so as to form a male track that includes a base portion 110 and sidewall portion 112 that continues the base portion 110. In this embodiment, the shape of the track is of a tubular shape. It should be understood that the base portions 106,110 and sidewall portions 108,112 are continuous integrated pieces. The slide 32, of FIG. 1, couples to the base 114 of male guide rail along positions 64-74. In this configuration, the male member can be inserted with the male member and the male member can slide forward and rearward.

In FIG. 2B, illustrated is an alternative female guide rail 116 and male guide rail 118 of FIGS. 1 and 2A wherein the tracks formed therein and thereon are of a semi-squared shape. The female guide rail 116 is shaped so as to form a female track that includes a base portion 120 and a sidewall portion 122. In this embodiment, the shape of the track is of a semi-square shape. The male guide rail 118 is also shaped so as to form a male track that includes a base portion 124 and sidewall portion 126. In this embodiment, the semi-square shape is further defined as having the horizontal base portions 120,124 and beveled sidewall portions 122, 126. However, it should be understood the sidewall portions 120,124 may not be beveled. In such case, the shapes formed would be square. Optionally, the male guide rail 118 may further include a track concentrator 128 to assist in guiding the male track along the female track. It should be understood that the base portions 120,124 and sidewall portions 122,126 are continuous integrated pieces. The slide 32, of FIG. 1, couples to the top base of male guide rail 118 along positions 64-74.

In FIG. 2C, illustrated is an alternative female guide rail 130 and male guide rail 132 of FIGS. 1A and 2 wherein the tracks formed therein and thereon are of a u-shape. The female guide rail 130 is shaped so as to form a female track that includes a base portion 134 and sidewall portion 136. In this embodiment, the shape of the track is of a u shape. The male guide rail 132 is also shaped so as to form a male track that includes a base portion 138 and a sidewall portion 140. In this embodiment, the u-shaped configuration formed by the female and male rails 130,132 includes a support member 142 that continues the female guide rail 130 and surrounds a portion of the male member as illustrated in FIG. 2C. In addition, the male track 132 includes a support base 144 that mates with the slide 32 in FIG. 1. In this configuration, the male member can be inserted with the male member and the male member can slide forward and rearward. It should also be understood that the support member 142 described can also be applied to the female guide rail 116 of FIG. 2B.

Referring now to FIG. 3, illustrated is the cargo slide 10 for a pickup truck in an extended position and denoted generally as 200. Cargo slide 200 includes female guide rails 16,18 and male guide rails 24,26. The slide 32 is physically attached with the male guide rails 24,26 along positions 64-74 of its top base. The platform 32 can be moved forward and rearward using handle 202. The platform 32 when moved forward and rearward causes the male tracks 28,30 of male guide rail 24,26 glide along the female tracks 20,22. The female tracks 22,22 encompass a significant portion of the male guide rails 24,26, providing the platform 32 with the support necessary as it is glided forward and rearward. Additional support may be provided in the form of leg stands 204,206.

Although the cargo slide illustrated in FIG. 3 is depicted using the tubular male and female guide rails as illustrated in FIGS. 1 and 2A, the bed slide 32 could also use the male and female guide rails illustrated in FIGS. 2B and 2C.

Thus, While there have been shown and described and pointed out fundamental novel features of the invention as applied to a preferred embodiment thereof, it will be under stood that various omissions and substitutions and changes in the form and details of the devices illustrated, and in their operation, may be made by those skilled in the art without departing from the spirit of the invention. For example, it is expressly intended that all combinations of those elements and/or method steps Which perform substantially the same function in substantially the same Way to achieve the same results are Within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A cargo moving apparatus for moving cargo within a bed of a pickup truck, the bed being bounded by a front wall and a tail gate, comprising:
a first and second female guide rail attachable to the bed that extends a length of the bed, the first and second guide rail having a horizontal top surface, horizontal with the bed, and a recessed space formed vertically along the horizontal top surface that forms a female track;
a first and second male guide rail having a top horizontal surface, horizontal with the bed, and a bottom surface that extends a length of the bed, the bottom surface includes a protruding member formed vertically along the bottom surface of the first and second male guide rail, the protruding member has a shape that forms a male track slidable when in contact with the female track; and
a platform slidably coupled with the first and second male guide rail so that the slide moves between a forward position and a rearward position when the first and second female guide rail and the first and second male guide are in contact.

2. The cargo moving apparatus as recited in claim 1 wherein the first and second male and female guide rails are made of plastic.

3. The cargo moving apparatus as recited in claim 1 wherein the female and male track includes congruent or near congruent base bottom section and sidewall sections.

4. The cargo moving apparatus as recited in claim 1 wherein the female and male track includes base bottom and sidewall sections that are curved.

5. The cargo moving apparatus as recited in claim 4 wherein the male track includes a track concentrator along the base bottom running the length of the male track.

6. The cargo moving apparatus as recited in claim 1 wherein the female and male track includes base bottoms that are flat and sidewall sections that are beveled.

7. The cargo moving apparatus as recited in claim 6 wherein the first and second female guide rail each include a support member that continues the horizontal top surface and surrounds their respective male guide rail when the male and female guide rails are interfaced.

8. The cargo moving apparatus as recited in claim 1 wherein the female and male track are further defined as:
the female track includes base bottom and sidewall sections that are semi-circular and have a top base plate for supporting the slide and the track formed is an outer tube extending the length of the female guide rail; and
the male track includes base bottom and sidewall sections that are semi-circular and having another top base plate for coupling with the slide and the track formed is an inner tube extending the length of the female guide rail that interfaces with the outer tube so that the inner tube slides rearward and forward through the outer tube.

10. A cargo moving apparatus for moving cargo within a bed of a pickup truck, the bed being bounded by a front wall and a tail gate, comprising:
a first and second female guide rail attachable to the bed and extending a length of the bed, the first and second female guide rail having a female track formed therein, wherein the female track is an outer tube extending the length of the female guide rail;
a first and second male guide rail extending a length of the bed and a male track formed thereon, the male track slidable when in contact with the female track, wherein the male track is an inner tube extending the length of the female guide rail and interfaces with the outer tube so that the inner tube slides rearward and forward through the outer tube; and
a platform slidably coupled with the first and second male guide rail so that the slide moves between a forward position and a rearward position when the first and second female guide rail and the first and second male guide are interfaced.

11. A cargo moving apparatus for moving cargo within a bed of a pickup truck, the bed being bounded by a front wall and a tail gate, comprising:
a first and second female guide rail attachable to the bed, the first and second guide rail having a horizontal top surface, horizontal with the bed, and further having a female track formed therein;
a first and second male guide rail having a top horizontal surface, horizontal with the bed, and a bottom surface that extends a length of the bed, the bottom surface includes a protruding member formed vertically along the bottom surface of the first and second male guide rail, the protruding member has a shape that forms a male track slidable when in contact with the female track;
the first and second female guide rail further including a support member that continues the top surface and surrounds their respective male guide rail when the male and female guide are interfaced; and
a platform slidably coupled with the first and second male guide rail so that the slide moves between a forward position and a rearward position when the first and second female guide rail and the first and second male guide are interfaced.

12. The cargo moving apparatus as recited in claim 11 wherein the female and male track includes base bottom and sidewall sections that are curved.

13. The cargo moving apparatus as recited in claim 11 wherein the female and male track includes base bottoms that are flat and sidewall sections that are beveled.
